(19) United States
(12) Patent Application Publication
(10) Pub. No.: US 2025/0138321 A1
(43) Pub. Date: May 1, 2025

(54) VIRTUAL-IMAGE DISPLAY DEVICE AND OPTICAL UNIT

(71) Applicant: SEIKO EPSON CORPORATION, Tokyo (JP)

(72) Inventors: Katsutoshi INOMOTO, SHIOJIRI-SHI, NAGANO-KEN (JP); Mitsutaka IDE, SHIOJIRI-SHI, NAGANO-KEN (JP); Takashi TAKEDA, SUWA-SHI, NAGANO-KEN (JP)

(73) Assignee: SEIKO EPSON CORPORATION, Tokyo (JP)

(21) Appl. No.: 18/923,708

(22) Filed: Oct. 23, 2024

(30) Foreign Application Priority Data
Oct. 26, 2023 (JP) 2023-183800

(51) Int. Cl. G02B 27/01; G02B 5/30; G02B 27/14

(52) U.S. Cl. CPC G02B 27/0172; G02B 5/3016; G02B 27/14; G02B 2027/0178

(57) ABSTRACT

A virtual-image display device or an optical unit includes a first display device configured to output image light of circularly polarized light; a first reflection member having a flat surface and configured to reflect the image light to a diagonal direction; and a second reflection member having a positive power and configured to reflect, toward the first reflection member, the image light reflected at the first reflection member. The first reflection member includes a first optical function layer that is one of a cholesteric liquid crystal layer and a transmissive reflection layer. The second reflection member includes a second optical function layer that is the other one of the cholesteric liquid crystal layer and the transmissive reflection layer.

The present application is based on, and claims priority from JP Application Serial Number 2023-183800, filed Oct. 26, 2023, the disclosure of which is hereby incorporated by reference herein in its entirety.

### BACKGROUND

### 1. Technical Field

The present disclosure relates to a see-through type virtual-image display device and an optical unit that make it possible to observe a virtual image.

### 2. Related Art

A folding optical system used for near-eye display is known (see JP-A-2021-532393). The optical system includes a circular polarizer, a partial reflector, and a reflective polarizer in the order from a display, and the reflective polarizer is a reflective type CLC circular polarizer, for example. In this optical system, light from the display passes through the circular polarizer to turn into, for example, left-handed circularly polarized light. After passing through the partial reflector, the light remains in the polarization state, and is reflected by the reflective polarizer. The left-handed circularly polarized light is still maintained, and reaches the partial reflector to be partially reflected. The left-handed circularly polarized light reflected by the partial reflector turns into right-handed circularly polarized light, and passes through the reflective polarizer in this state. Here, the light from the display is reflected twice within a cavity formed by the partial reflector and the reflective polarizer. This makes it possible to increase the length of the optical path while preventing an increase in the physical entire length.

In a case of the virtual-image display device in JP-A-2021-532393, the display is disposed in front of eyes. Thus, there is a problem concerning light shielding by the display in terms of light coming from surrounding environments. Note that, in a case of a birdbath-type virtual-image display device in which a half mirror having a concave surface and a half mirror having a flat surface are combined together, the light shielding by the display described above does not cause a problem. However, light utilization efficiency is low, and image light is more likely to leak to the outside.

### SUMMARY

A virtual-image display device according to one aspect of the present disclosure includes a display section configured to output image light of circularly polarized light, a first reflection member having a flat surface and configured to reflect the image light to a diagonal direction, and a second reflection member having a positive power and configured to reflect, toward the first reflection member, the image light reflected at the first reflection member, in which the first reflection member includes a first optical function layer that is one of a cholesteric liquid crystal layer and a transmissive reflection layer, and the second reflection member includes a second optical function layer that is the other one of the cholesteric liquid crystal layer and the transmissive reflection layer.

### BRIEF DESCRIPTION OF THE DRAWINGS

FIG. 1 is a diagram illustrating the external appearance used to explain a use state of a virtual-image display device according to a first embodiment.

FIG. 2 is a side cross-sectional view used to explain an internal structure of a display device at one side.

FIG. 3 is a perspective view used to explain an external structure of a first display optical system.

FIG. 4 is a conceptual diagram used to explain polarization states of image light or the like in the device illustrated in FIG. 2.

FIG. 5 is a diagram used to explain a modification example concerning the first display section of the device illustrated in FIG. 2.

FIG. 6 is a diagram used to explain another modification example of the device illustrated in FIG. 2.

FIG. 7 is a side cross-sectional view used to explain a virtual-image display device according to a second embodiment.

FIG. 8 is a conceptual diagram used to explain polarization states of image light or the like in the device illustrated in FIG. 7.

FIG. 9 is a side cross-sectional view used to explain a virtual-image display device according to a third embodiment.

FIG. 10 is a conceptual diagram used to explain polarization states of image light or the like in the device illustrated in FIG. 9.

FIG. 11 is a diagram used to explain a modification example of the device illustrated in FIG. 9.

FIG. 12 is a side cross-sectional view used to explain a virtual-image display device according to a fourth embodiment.

FIG. 13 is a conceptual diagram used to explain polarization states of image light or the like in the device illustrated in FIG. 12.

### DESCRIPTION OF EMBODIMENTS

### First Embodiment

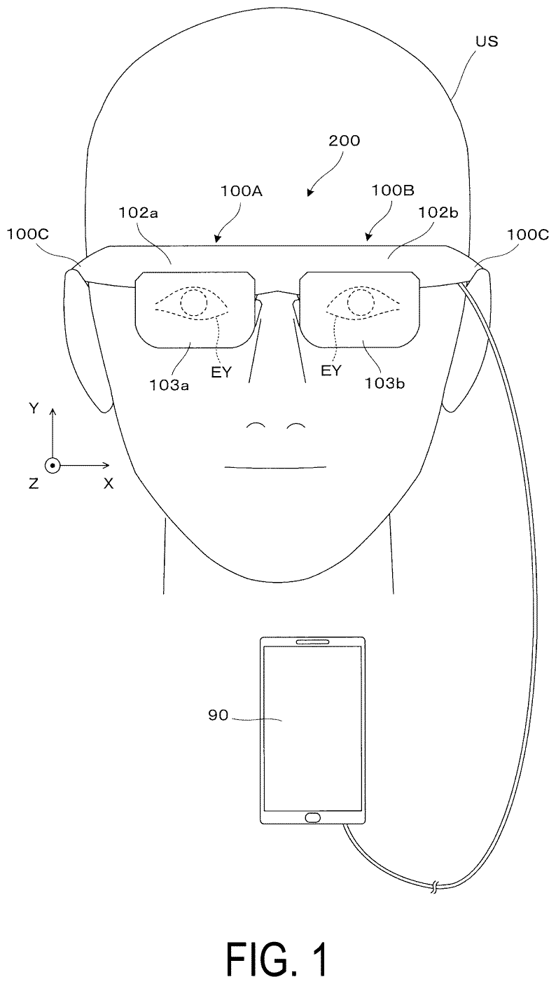

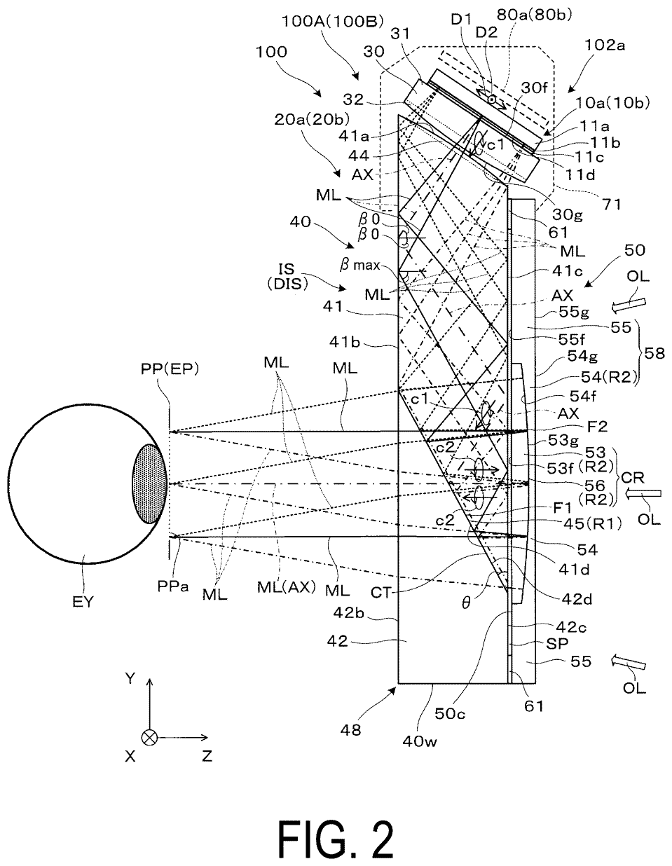

Below, a first embodiment of a virtual-image display device or the like according to the present disclosure will be described with reference to FIGS. 1, 2, and the like.

FIG. 1 is a diagram used to explain a state in which a head-mounted type virtual-image display device (hereinafter, also referred to as a head-mounted display or an “HMD”) 200 is mounted, and the HMD 200 enables an observer or wearer US, who wears the HMD 200, to recognize an image as a virtual image. In FIG. 1 and the like, X, Y, and Z represent a rectangular coordinate system. The +X direction corresponds to a lateral direction in which both eyes EY of the observer or the wearer US, who wears the HMD 200, are arranged. The +Y direction corresponds to the upward direction perpendicular to the lateral direction from the viewpoint of the wearer US in which both the eyes EY are arranged. The +Z direction corresponds to the forward direction or the front side direction from the viewpoint of the wearer US. The +Y direction is parallel to the vertical axis or the vertical direction.

The HMD 200 includes a right-eye first virtual-image display device 100A of direct virtual-image type, a left-eye second virtual-image display device 100B of direct virtual-image type, a pair of temple-type supporting devices 100C that support these virtual-image display devices 100A and 100B, and a user terminal 90 that is an information terminal. The first virtual-image display device 100A alone functions as the HMD, and includes a first display driving unit 102a disposed at an upper portion, and a first combiner 103a having a shape of a spectacle lens and covering the front of an eye. Similarly, the second virtual-image display device 100B alone functions as the HMD, and includes a second display driving unit 102b disposed at the upper portion, and a second combiner 103b having a shape of a spectacle lens and covering the front of an eye. The supporting devices 100C are mounting members mounted on a head of the wearer US, and support upper ends of the pair of combiners 103a and 103b via the display driving units 102a and 102b that are integrated in appearance. The first virtual-image display device 100A and the second virtual-image display device 100B are optically identical or left-right inverted. Thus, detailed explanation of the second virtual-image display device 100B will not be made.

FIG. 2 is a side cross-sectional view used to explain the internal structure of the first virtual-image display device 100A. The first virtual-image display device 100A includes a first display section 10a, a first display optical system 20a, and a first circuit member 80a. The first display section 10a is configured to output image light ML of circularly polarized light. The first display optical system 20a is an image-forming optical system IS configured to directly form a virtual image without forming any intermediate image, and is also referred to as a direct virtual-image optical system DIS. The image-forming optical system IS includes a first combining lens 30, a first flat-plate member 40, and a second flat-plate member 50. The first combining lens 30 functions as a protecting glass configured to protect the first display section 10a. The first flat-plate member 40 guides the image light ML outputted from the first display section 10a to a first lens 53 of the second flat-plate member 50. The second flat-plate member 50 reflects the image light ML coming from the first flat-plate member 40 toward a pupil position PP or the eye EY so as to return the light to the first flat-plate member 40 while allowing the outside light to enter the pupil position PP through the first flat-plate member 40. The first combining lens 30, the first flat-plate member 40, and the second flat-plate member 50 each function as a lens having a positive power.

The second virtual-image display device 100B includes a second display section 10b, a second display optical system 20b, and a second circuit member 80b, although detailed description will not be given. The second display section 10b is similar to the first display section 10a. The second display optical system 20b is similar to the first display optical system 20a. The second circuit member 80b is similar to the first circuit member 80a. The second display optical system 20b includes a first combining lens 30, a first flat-plate member 40, and a second flat-plate member 50.

In the first virtual-image display device 100A, the first display section 10a outputs image light ML of circularly polarized light through the first combining lens 30 to the first flat-plate member 40. The first display section 10a together with the first circuit member 80a is accommodated and is supported in a case 71. The first display section 10a includes a display element 11a configured to output image light ML containing polarized light in one direction or two directions, a polarizing plate 11b disposed so as to be opposed to the display element 11a, and a quarter wavelength plate 11c disposed on an opposite side of the polarizing plate 11b opposite from the display element 11a.

The display element 11a is a self-emission type image-light generation device. The display element 11a is, for example, an organic electro-luminescence (organic EL) display, and is configured to form a color still image or video on a two-dimensional display surface 11d. The display element 11a is driven by the first circuit member 80a, and performs a display operation. The display element 11a is not limited to the organic EL display, and can be replaced with a display device using an inorganic EL, an organic LED, an LED array, a laser array, a quantum-dot emission type element, or the like. The display element 11a is not limited to the self-emission type image-light generation device, and may be an optical modulation element such as a digital micro-mirror device or the like. In this case, this optical modulation element is illuminated with a light source such as back light to form an image. Note that, in the first virtual-image display device 100A, optical devices except for the first circuit member 80a are referred to as an optical unit 100. The optical unit 100 includes a direct virtual-image type optical system, and it may be possible to say that the optical unit 100 is a portion corresponding to the direct virtual-image optical system DIS that constitutes the first virtual-image display device 100A.

The polarizing plate 11b limits the polarization direction of the image light ML outputted from the display element 11a, to a D1 direction parallel to the YZ plane, for example. The fast axis or the slow axis of the quarter wavelength plate 11c is set to an intermediate direction between the D1 direction and a D2 direction perpendicular to the optical axis AX, and converts the linear polarization passing through the polarizing plate 11b into right-handed circularly polarized light c1. Here, the “image light ML being circularly polarized light” means that, when attention is paid to oscillation of an electric field or magnetic field of the image light ML, the direction of the oscillation rotates at the frequency of the image light ML within a plane perpendicular to the direction of propagation of the light, and the amplitude thereof remains constant regardless of the direction. The right-handed circularly polarized light is light in which the direction of oscillation of an electric field rotates clockwise as viewed from an observer who stands toward a direction in which the beam travels, and rotates in a direction opposite to the left-handed circularly polarized light. However, in the present description, when the image light ML mainly contains the right-handed circularly polarized light, such image light ML is assumed to be the right-handed circularly polarized light c1 even if the light contains linear polarization in a specific direction, for example.

When the display element 11a outputs only the polarized light in the D1 direction as the image light ML, it is possible to omit the polarizing plate 11b. Specifically, when the display element 11a is an optical modulation element such as an LCD, a light emitting part of the display element 11a is provided with a polarizer, and hence, the polarizing plate 11b is not necessary. The polarizing plate 11b is also not necessary when a liquid crystal on silicon (LCOS, LCOS is a registered trademark) is used as the display element 11a instead of the LCD. Similarly, the polarizing plate 11b is also not necessary when the display element 11a is a laser array or the like configured to output only polarized light in the D1 direction as the image light ML.

The first display unit 20a includes the first combining lens 30, the first flat-plate member 40, and the second flat-plate member 50. The first flat-plate member 40 includes a transmissive reflection layer 45 as a first function layer F1 of a first reflection member R1. The second flat-plate member 50 includes a cholesteric liquid crystal layer 56 as a second function layer F2 of a second reflection member R2. In the first display unit 20a, the first combining lens 30 has a positive power, and the image light ML from the first display section 10a enters the first combining lens 30. The first combining lens 30 includes a light incident surface 30f having a flat surface and bonded to the first display section 10a, and a light emission surface 30g having a convex surface. The light emission surface 30g is, for example, a spherical surface. However, it may be possible that the light emission surface 30g has an aspheric surface having an axial symmetry shape. The first combining lens 30 can be considered to be divided into a parallel flat plate 31 and a lens section 32. By ensuring the parallel flat plate 31 to have a thickness not less than a predetermined thickness, foreign materials attached on the front surface of the first combining lens 30 can be less stand out. The lens section 32 is a plano-convex lens. The first combining lens 30 is made, for example, of fused quartz, and has a relatively low refractive index.

The first flat-plate member 40 includes a first prism 41 having a parallel flat-plate shape, a second prism 42 having a parallel flat-plate shape, and the transmissive reflection layer 45 disposed so as to be interposed between these prisms. The first prism 41 and the second prism 42 are bonded at sloped surfaces 41d and 42d. A component obtained by bonding the first prism 41 and the second prism 42 together is referred to as a prism light-guiding member 48. The prism light-guiding member 48 has the external appearance of a parallel flat plate. The transmissive reflection layer 45 having a flat surface is formed at the sloped surface 41d formed at the lower side of the first prism 41. A component obtained by combining the prism light-guiding member 48 and the second flat-plate member 50 that will be described later corresponds to the first combiner 103a in FIG. 1.

The first prism 41 has a square post-shape in external appearance, and has a trapezoid shape in cross section. The first prism 41 is used to guide the image light ML, and includes an incident optical surface 41a, an inner-side surface 41b, an outer-side surface 41c, and the sloped surface 41d. Here, the incident optical surface 41a is sloped downward at the front as a whole. The optical axis AX passing through the incident optical surface 41a extends in a direction between the −Z direction that is the rearward and the −Y direction that is the downward. This configuration makes it possible to easily dispose the first display section 10a more toward the side of the outer world than the inner-side surface 41b, and to adjust the angle at which the image light ML propagates within the first prism 41. The incident optical surface 41a is a convex surface, and is, for example, a spherical surface. However, it may be possible that the incident optical surface 41a is an axially symmetric aspheric surface. It can be considered that the first prism 41 includes a second combining lens 44 including the incident optical surface 41a. The second combining lens 44 is a convex-plano lens having a positive power. The inner-side surface 41b and the outer-side surface 41c are parallel to each other, and extend perpendicularly with respect to the optical axis AX between the component and the pupil position PP. The inner-side surface 41b and the outer-side surface 41c are configured to internally reflect the image light ML (in other words, they are configured to reflect the light at the inner side of the front surface of an object). In particular, it is desirable that these surfaces be configured to make total reflection. By applying hard coating, it is possible to increase an anti-damage property or anti-scratch property of the inner-side surface 41b. The sloped surface 41d is a flat surface. The sloped surface 41d is configured so as to form an acute angle with the outer-side surface 41c. Specifically, this angle falls in a range of 25° to 32°. Note that the distance between the optical axis AX passing through the pupil position PP and the upper end of the first combining lens 30 is approximately 20 mm. The first prism 41 is made of a resin material, and has a refractive index higher than the refractive index of the first combining lens 30.

The second combining lens 44 may not be provided. In other words, the incident optical surface 41a may be a flat surface.

The number of times of reflection of the image light ML at the first prism 41 is one at the inner-side surface 41b, and is one at the outer-side surface 41c. In addition, the light is reflected once at the transmissive reflection layer 45 that will be described later. By causing the image light ML to be internally reflected twice within the first prism 41, it is possible to avoid mixture of beams of light that are reflected within the first prism 41 different numbers of times while increasing the angle of view of the image light ML and the pupil position PP or its opening PPA. An intermediate image is not formed at the first display unit 20a or the image-forming optical system IS. Thus, the image light ML reflected at the inner-side surface 41b and the outer-side surface 41c less diverges than the light originally outputted from the first display section 10a, that is, from the display element 11a. However, the light still enters the inner-side surface 41b and the outer-side surface 41c in a diverged state, and maintains the diverged state.

The second prism 42 has a square post-shape in external appearance, and has a trapezoid shape in cross section, as with the first prism 41. The second prism 42 allows the image light ML to pass through, and includes an inner-side surface 42b, an outer-side surface 42c, and the sloped surface 42d. Here, the inner-side surface 42b and the outer-side surface 42c are parallel to each other, and extend perpendicularly with respect to the optical axis AX between the component and the pupil position PP. By applying hard coating, it is possible to increase an anti-damage property of the inner-side surface 42b. The second prism 42 is made of a resin material, and has a refractive index equal to the refractive index of the first prism 41.

The transmissive reflection layer 45 is a first reflection member R1 having a flat surface and configured to reflect the image light ML in a diagonal direction. The transmissive reflection layer 45 is formed integrally on the sloped surface 41d of the first prism 41, and is interposed between the sloped surface 41d of the first prism 41 and the sloped surface 42d of the second prism 42. In other words, the transmissive reflection layer 45 is provided at a location where the first prism 41 and the second prism 42 are bonded together. A portion between the transmissive reflection layer 45 and the sloped surface 42d is filled with a glue material CT for bonding. The transmissive reflection layer 45 is comprised of a single-layer film or multi-layer film including a metal such as Al, Ag, or the like and having an adjusted thickness. The transmissive reflection layer 45 is formed through stacking using, for example, vapor deposition. The transmissive reflection layer 45 may be a dielectric multilayer film including a plurality of dielectric layers having an adjusted thickness. The reflectance of the transmissive reflection layer 45 with respect to the image light ML or the external light OL is, for example, equal to or more than 50% in an incident angle range of the assumed image light ML from the viewpoint of securing the brightness of the image light ML or facilitating observation of the outside-world image in a see-through manner.

The tilt angle θ of the transmissive reflection layer 45 is set to θ=β0/2 when β0 is the reflective angle of the image light ML on the optical axis AX in the first prism 41. On the assumption that the transmissive reflection layer 45 does not block the path of the image light ML, it is desirable that the tilt angle θ of the transmissive reflection layer 45 should be smaller than the 90°−βmax when βmax is the maximum reflective angle of the image light ML. The reflective angle 80 of the image light ML corresponds to an angle formed by the normal line to the inner-side surface 41b and the optical axis AX passing through the incident optical surface 41a.

The second flat-plate member 50 includes the plano-convex first lens 53, a concave-plano second lens 54, a compensation flat plate 55 provided around the second lens 54, and the cholesteric liquid crystal layer 56 disposed so as to be interposed between the first lens 53 and the second lens 54.

The second flat-plate member 50 is disposed so as to be spaced apart from the first flat-plate member 40 by approximately 20 μm to 50 μm, for example. By setting the distance between the inner-side surface 50c and the outer-side surfaces 41c and 42c to not less than 20 μm, preferably to not less than 30 μm, it is possible to prevent these surfaces from being excessively close to each other. Furthermore, by setting the distance between the inner-side surface 50c and the outer-side surfaces 41c and 42c to not less than 50 μm, it is possible to prevent an increase in the thickness of the first combiner 103a obtained by combining the first flat-plate member 40 and the second flat-plate member 50 together. A spacer 61 is provided between the inner-side surface 50c of the second flat-plate member 50 and the outer-side surfaces 41c and 42c of the first flat-plate member 40. The spacer 61 is used to adjust the space between the first flat-plate member 40 and the second flat-plate member 50 and fix the space in a state where they are positioned relative to each other. The spacer 61 is not provided throughout the entire periphery of the second flat-plate member 50. In other words, the space SP between the first flat-plate member 40 and the second flat-plate member 50 is not sealed, and communicates with the outside.

Although being thin, the first lens 53 has a positive power, and includes a flat surface 53f that is opposed to the outer-side surfaces 41c and 42c of the first flat-plate member 40, and a convex surface 53g that is opposed to the second lens 54. The convex surface 53g is, for example, a spherical surface. However, it may be possible that the convex surface 53g is an axially symmetric aspheric surface. Although being thin, the second lens 54 has a negative power, and includes a concave surface 54f that is opposed to the first lens 53, and a flat surface 54g. The compensation flat plate 55 is a parallel flat plate, and includes a pair of flat surfaces 55f and 55g. Here, the concave surface 54f of the second lens 54 has the same shape as the convex surface 53g of the first lens 53. The flat surface 53f of the first lens 53 and the flat surface 55f of the compensation flat plate 55 are disposed on the same flat surface. The flat surface 54g of the second lens 54 and the flat surface 55g of the compensation flat plate 55 are disposed on the same flat surface and continue with each other. The cholesteric liquid crystal layer 56 is a thin membrane formed on the convex surface 53g of the first lens 53, and has the same shape as the convex surface 53g. A component obtained by combining the first lens 53 and the cholesteric liquid crystal layer 56 together is referred to as a condensing reflection section CR.

The first lens 53, the second lens 54, and the compensation flat plate 55 are made of resin material, and have the same refractive index. The refractive index of the first lens 53 or the like is lower than the refractive index of the first prism 41. The second lens 54 and the compensation flat plate 55 constitute an optical element 58 formed integrally of the same resin material. A component obtained by combining the first lens 53, the second lens 54, and the compensation flat plate 55 together functions as a parallel flat plate as a whole. In other words, the external light OL entering at a position of the second lens 54 or the compensation flat plate 55 passes through these components without receiving any influence of lens action from the second lens 54 or the like or any influence of a step existing at the outer edge of the second lens 54. Anti-reflection coating or hard coating can be applied to the flat surfaces 54g of the second lens 54 and the flat surface 55g of the compensation flat plate 55. The external light OL passing through the compensation flat plate 55 is light that enters the second flat-plate member 50 from the upward, downward, left, and right of the second lens 54, that is, from the surrounding region at the outer side than the region where the image light ML enters. This makes it possible to secure the wide see-through visual field with respect to the outside world. The visual field range of the external light OL is set, for example, to approximately 40° in the upward direction and approximately 40° in the downward direction.

The diameter of the first lens 53 is set so as to fall in a range of 20 mm to 25 mm from the viewpoint of securing the angle of view. Note that the thickness, in the Z direction, of the first flat-plate member 40 or the prism light-guiding member 48 falls in a range of 6 mm to 8 mm. The distance from the inner-side surface 41b, 42b of the first flat-plate member 40 to the pupil position PP falls in a range of approximately 12 mm to 13 mm. Thus, it is possible to set approximately 40° as the angle of view (diagonal) that is the angle range in which the image light ML enters the pupil position PP.

The cholesteric liquid crystal layer 56 is the second reflection member R2 or a portion of this member. The second reflection member R2 is configured to reflect, toward the transmissive reflection layer 45, the image light ML reflected at the transmissive reflection layer 45 that is the first reflection member R1. The cholesteric liquid crystal layer 56 selectively reflects the image light ML that is left-handed circularly polarized light c2 as a result of reflection at the transmissive reflection layer 45 while maintaining the state of being the left-handed circularly polarized light c2. In other words, the cholesteric liquid crystal layer 56 hardly allows the image light ML to pass through, and prevents the image light ML from being outputted to the outside. On the other hand, since the external light OL contains right-handed circularly polarized light or left-handed circularly polarized light, the cholesteric liquid crystal layer 56 allows the right-handed circularly polarized light to pass through. In other words, the cholesteric liquid crystal layer 56 partially allows the external light OL to pass through. The cholesteric liquid crystal layer 56 reflects, toward the pupil position PP, the image light ML that has been reflected at the transmissive reflection layer 45 of the first flat-plate member 40 and passed through the first lens 53. The image light ML that has been reflected at the cholesteric liquid crystal layer 56 partially passes through the transmissive reflection layer 45 of the prism light-guiding member 48, and enters the pupil position PP. The cholesteric liquid crystal layer 56 is a concave surface mirror that covers the pupil position PP at which the eye EY or the pupil is disposed, has a concave shape toward the pupil position PP, and has a convex shape toward the outside world. The pupil position PP or an opening PPa thereof is referred to as an eye point or an eye box, and corresponds to an emission pupil EP of the first display unit 20a.

The cholesteric liquid crystal layer 56 allows a portion of the external light OL to pass through. This makes it possible to achieve see-through view of the outside world, which makes it possible to overlap a virtual image with the outside-world image. At this time, the external light OL passes through the first flat-plate member 40 and the second flat-plate member 50. However, the flat-plate member 40 or 50 does not cause lens action to the external light OL.

The cholesteric liquid crystal layer 56 has a layered structure of molecules oriented in a certain direction, and the molecule orientation axes of these layers are twisted between adjacent layers. In this structure as a whole, the orientation directions form a helical structure around the vertical axis of layers. The cholesteric liquid crystal layer 56 is made of a predetermined liquid crystal material, and has a characteristic in which the right-handed circularly polarized light c1 is allowed to pass through, and the left-handed circularly polarized light c2 is reflected. The cholesteric liquid crystal layer 56 becomes a liquid crystal layer having less fluidity and in a stable state, by interposing a liquid-crystal base material containing a liquid crystal material or additive between the first lens 53 and the second lens 54, and irradiating the liquid-crystal base material interposed between these lenses with UV light or the like in a state where the first lens 53 and the second lens 54 are fixed relatively to each other, or removing or vaporizing a solvent from the liquid-crystal base material interposed between these lenses, or heating the liquid-crystal base material interposed between these lenses. The cholesteric liquid crystal layer 56 may be configured, for example, such that the layer is cured on the front surface of one of the first lens 53 and the second lens 54, and the other one of the first lens 53 and the second lens 54 is bonded and is interposed between them. Note that, in manufacturing of the cholesteric liquid crystal layer 56, it is possible to apply a method described in JP-T-2008-501147 or JP-T-2021-532393.

In the first virtual-image display device 100A, the first combining lens 30, the second combining lens 44, the first lens 53, and the cholesteric liquid crystal layer 56 each have a positive power, and have a tendency of converging the divergent light. In addition to the main body of the first prism 41, the second prism 42, and the like, the first combining lens 30, the second combining lens 44, the first lens 53, and the cholesteric liquid crystal layer 56 function as an image-forming optical system IS or a direct virtual-image optical system DIS such as a single microscope-type microscope that forms an erect image. For example, this makes it possible to form a virtual image obtained by projecting, at an infinite distance, a real image formed on the display surface 11d of the display element 11a, or form a virtual image obtained by projecting, several meters away, a real image formed on the display surface 11d. At this time, by adjusting the refracting power or power of the first combining lens 30, the second combining lens 44, the first lens 53, and the cholesteric liquid crystal layer 56, it is possible to reduce the focal length of the image-forming optical system IS to achieve a desired magnifying power.

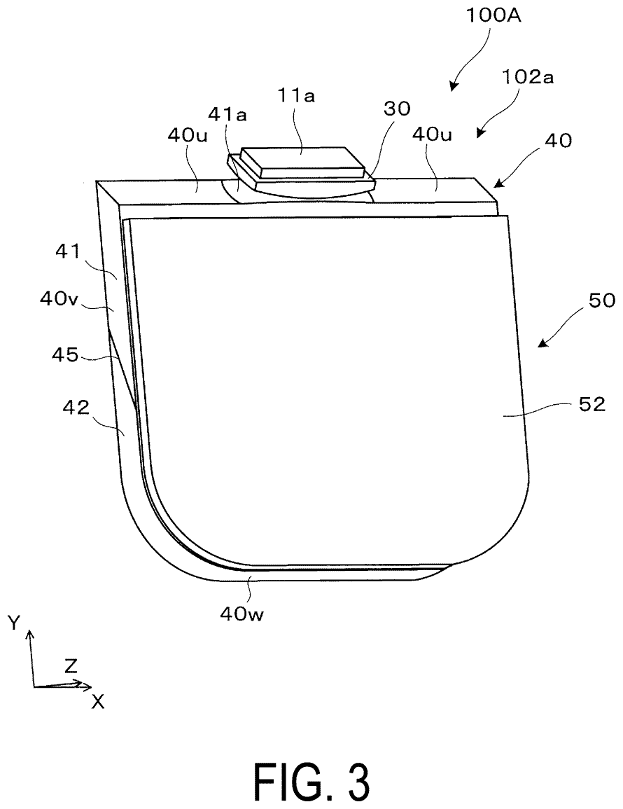

With reference to FIG. 3, the size, in the height and width, that is, in the XY direction, of the first flat-plate member 40 or the second flat-plate member 50 is, for example, approximately 34 mm×40 mm. The thickness, in the front-rear direction, of the combination of the first flat-plate member 40 and the second flat-plate member 50 is reduced to approximately 7.5 mm. The size, in the width and depth, of the display element 11a and the first combining lens 30 is, for example, approximately 7 mm×14 mm.

In the first flat-plate member 40, an upper flat surface 40u is provided at the left and the right of the incident optical surface 41a. Light is not caused to enter the upper flat surface 40u. A light-shielding body (not illustrated) disposed so as to be opposed to the upper flat surface 40u and configured to cover the upper flat surface 40u may be disposed at the upper flat surface 40u from the viewpoint of preventing stray light. Alternatively, a light-shielding body may be applied to the upper flat surface 40u. It may be possible that a side flat surface 40v or a lower flat surface 40w is provided with a light-shielding body or the like configured to cover this flat surface. In addition, it may be possible that a light-shielding body or the like is provided in the vicinity of the second flat-plate member 50, and the light-shielding body or the like is configured to cover the member.

The radius of curvature of the convex light emission surface 30g of the first combining lens 30 is, for example, 20 mm. In addition, the radius of curvature of the incident optical surface 41a of the first prism 41 is, for example, 14 mm. Furthermore, the radius of curvature of the cholesteric liquid crystal layer 56 is, for example, 47 mm.

The optical path will be described with reference to FIG. 2 and the like. The image light ML, which is the right-handed circularly polarized light c1 and is outputted from the first display section 10a, passes through the first combining lens 30 and enters the first prism 41. At this time, the degree of spreading-out of the image light ML is reduced with the positive power that the first combining lens 30 and the second combining lens 44 have. In the optical path passing through the first prism 41, the image light ML is reflected sequentially at the inner-side surface 41b of the first prism 41 and the outer-side surface 41c of the first prism 41 without forming any intermediate image, and a portion of the image light ML is reflected at the transmissive reflection layer 45. The image light ML reflected at the transmissive reflection layer 45 turns into the left-handed circularly polarized light c2. The image light ML reflected at the transmissive reflection layer 45 passes through the outer-side surface 41c of the first prism 41 to pass through the first lens 53, and enters the cholesteric liquid crystal layer 56. The left-handed circularly polarized light c2 enters the cholesteric liquid crystal layer 56, and most of the light is reflected at the cholesteric liquid crystal layer 56. Then, the light passes through the first lens 53 to be collimated. The light enters the first prism 41 from the outer-side surface 41c, and partially passes through the transmissive reflection layer 45. Then, the light is outputted through the inner-side surface 42b to the outside of the second prism 42. The image light ML that has been outputted to the outside of the second prism 42 enters the pupil position PP where the eye EY or pupil of the wearer US is disposed. Not only the image light ML reflected at the cholesteric liquid crystal layer 56 but also the external light OL that has passed through the cholesteric liquid crystal layer 56 and the external light OL that has passed through the compensation flat plate 55 enter the pupil position PP. In other words, the wearer US who wears the first virtual-image display device 100A is able to observe a virtual image resulting from the image light ML so as to overlap with the outside-world image.

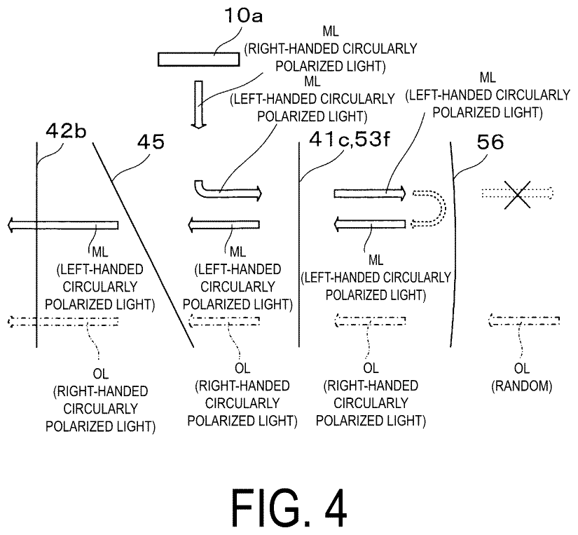

With reference to FIG. 4, the image light ML from the first display section 10a is right-handed circularly polarized light. The light is reflected at the inner-side surface 41b and the outer-side surface 41c of the first prism 41, and enters the transmissive reflection layer 45 in a state of the right-handed circularly polarized light. The image light ML reflected at the transmissive reflection layer 45 is converted from the right-handed circularly polarized light into the left-handed circularly polarized light, and passes through the outer-side surface 41c and the like to enter the cholesteric liquid crystal layer 56. The image light ML reflected at the cholesteric liquid crystal layer 56 is maintained to be the left-handed circularly polarized light, and passes through the outer-side surface 41c, the transmissive reflection layer 45, and the inner-side surface 42b in a state of the left-handed circularly polarized light. With the configuration described above, since the cholesteric liquid crystal layer 56 reflects most of the image light ML that is the left-handed circularly polarized light, most of the image light ML is blocked by the second flat-plate member 50, and the light does not leak to the outside. In other words, it is possible to prevent the image light ML from being observed from the outside, which makes it possible to ensure privacy.

As for the external light OL, the right-handed circularly polarized light selectively passes through the cholesteric liquid crystal layer 56, and passes through the outer-side surface 41c, the transmissive reflection layer 45, and the inner-side surface 42b in a state of the right-handed circularly polarized light.

In the description above, it is assumed that the reflectance of the transmissive reflection layer 45 is set to 50%, for example. In this case, the image light ML outputted from the display element 11a is attenuated by the polarizing plate 11b to 50%, for example, and is further attenuated by the transmissive reflection layer 45 to 25%. However, even if reflected at the cholesteric liquid crystal layer 56, the light is still maintained at 25% with the original display element 11a being a reference. The intensity of the image light ML that has passed through the transmissive reflection layer 45 and entered the pupil position PP turns to 12.5% with the original display element 11a being a reference. The external light OL is maintained at the 50% that is the original state.

The first display section 10a is not limited to a component configured to output the image light ML having a specific wavelength. It may be possible to employ a component configured to output color image light ML. In this case, it is desirable that the cholesteric liquid crystal layer 56 should also be a component that corresponds to a visible frequency band. In order to cause the cholesteric liquid crystal layer 56 to deal with a plurality of wavelengths, it may be possible to employ a multiple layer structure including an element layer corresponding to each color of RGB, for example.

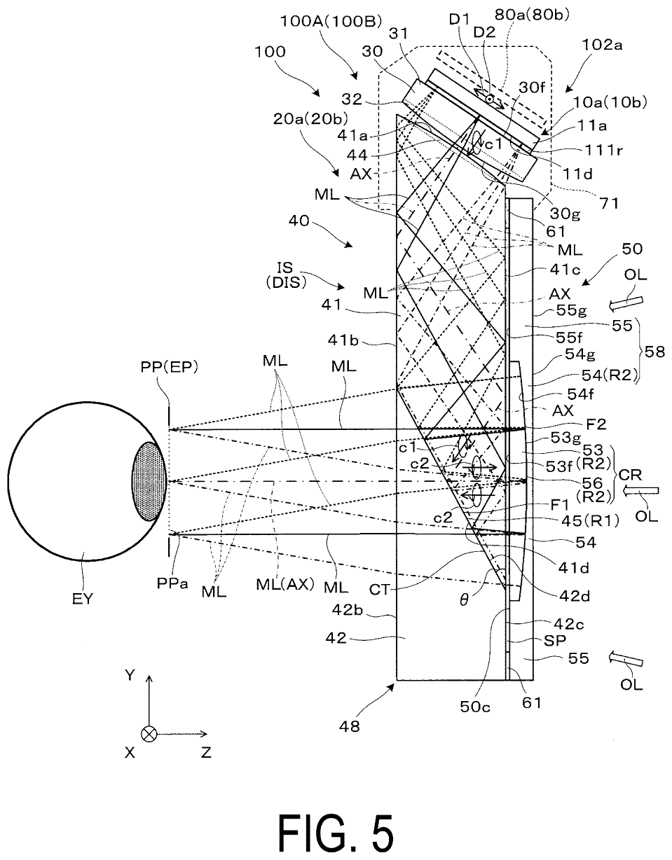

FIG. 5 is a diagram used to explain a modification example of the first display section 10a illustrated in FIG. 2. In this case, the first display section 10a includes the display element 11a configured to output the image light ML containing polarized light in one direction or two directions, and a cholesteric liquid-crystal element 111r disposed so as to be opposed to the display element 11a. The cholesteric liquid-crystal element 111r allows only a component of the right-handed circularly polarized light c1 to selectively pass through from among the image light ML outputted from the display element 11a. In other words, only the right-handed circularly polarized light c1 is outputted from the first display section 10a as the image light ML.

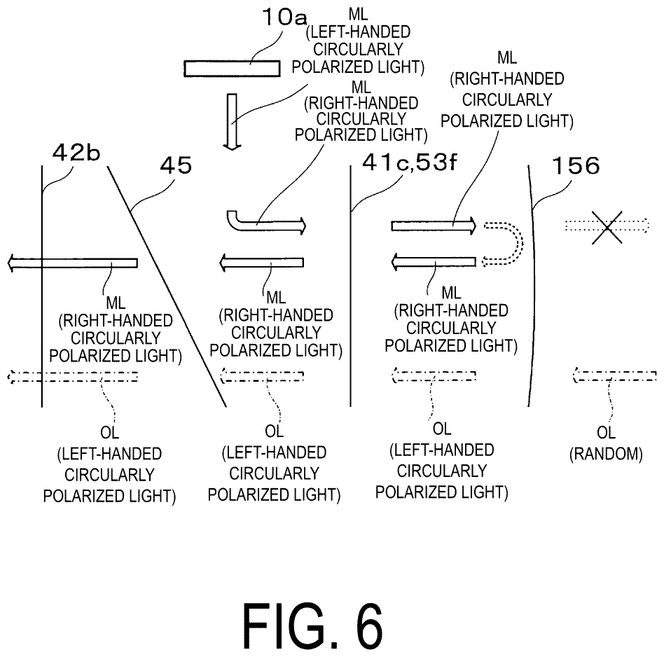

FIG. 6 is a diagram used to explain another modification example of the first display section 10a illustrated in FIG. 2. In this case, the image light ML outputted from the first display section 10a is left-handed circularly polarized light. In addition, a cholesteric liquid crystal layer 156 allows the left-handed circularly polarized light to pass through, and reflects the right-handed circularly polarized light. In this case, most of the image light ML is blocked by the second flat-plate member 50 or the cholesteric liquid crystal layer 56, and the image light ML does not leak to the outside. On the other hand, the second flat-plate member 50 allows the external light OL to pass through. This enables the wearer US to overlap the outside-world image to observe a virtual image resulting from the image light ML.

The virtual-image display device 100A and 100B or the optical unit 100 according to the first embodiment described above includes: the first display device 10 configured to output the image light ML of circularly polarized light; the first reflection member R1 having a flat surface and configured to reflect the image light ML in a diagonal direction; and the second reflection member R2 having a positive power and configured to reflect, toward the first reflection member R1, the image light ML reflected at the first reflection member R1, in which the first reflection member R1 includes the first optical function layer F1 that is one of the cholesteric liquid crystal layer 56 and the transmissive reflection layer 45, and the second reflection member R2 includes the second optical function layer F2 that is the other one of the cholesteric liquid crystal layer 56 and the transmissive reflection layer 45.

With the virtual-image display device, since the first reflection member R1 reflects the image light ML in a diagonal direction, it is possible to avoid optical arrangement in which the display section 10a is disposed in front of an eye. In addition, since these virtual-image display devices 100A and 100B are configured such that one of the first reflection member R1 and the second reflection member R2 includes the cholesteric liquid crystal layer 56, and the other one of the first reflection member R1 and the second reflection member R2 includes the transmissive reflection layer 45, it is possible to efficiently reflect the image light ML by the cholesteric liquid crystal layer 56 while changing the direction of the circularly polarized light by the transmissive reflection layer 45, which makes it possible to easily enhance light utilization efficiency.

In the virtual-image display device 100A and 100B according to the first embodiment, the first reflection member R1 includes the transmissive reflection layer 45 as the first optical function layer F1, and the second reflection member R2 includes the cholesteric liquid crystal layer 56 as the second optical function layer F2. In this case, most of the circularly polarized light reflected at the transmissive reflection layer 45 of the first reflection member R1 is reflected at the cholesteric liquid crystal layer 56 of the second reflection member R2. This makes it possible to prevent the image light ML from leaking to the outside world.

### Second Embodiment

Below, a virtual-image display device or the like according to a second embodiment will be described. Note that the virtual-image display device according to the second embodiment is provided by partially modifying the virtual-image display device according to the first embodiment. Thus, explanation of portions common to the virtual-image display device according to the first embodiment will not be repeated.

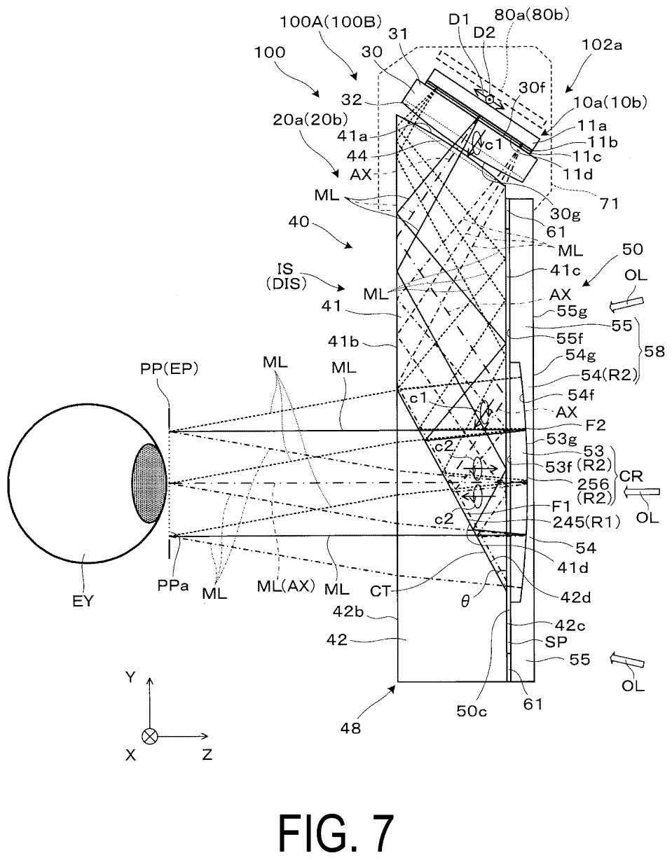

In the virtual-image display device 100A or the optical unit 100 illustrated in FIG. 7, a cholesteric liquid crystal layer 245 is used as the first optical function layer F1 of the first reflection member R1, and a transmissive reflection layer 256 is used as the second optical function layer F2 of the second reflection member R2. The cholesteric liquid crystal layer 245 that is the first optical function layer F1 is similar to the cholesteric liquid crystal layer 56 illustrated in FIG. 2. The transmissive reflection layer 256 that is the second optical function layer F2 is similar to the transmissive reflection layer 45 illustrated in FIG. 2. In other words, the positions of the cholesteric liquid crystal layer 245 and the transmissive reflection layer 256 are swapped, as compared with the first embodiment.

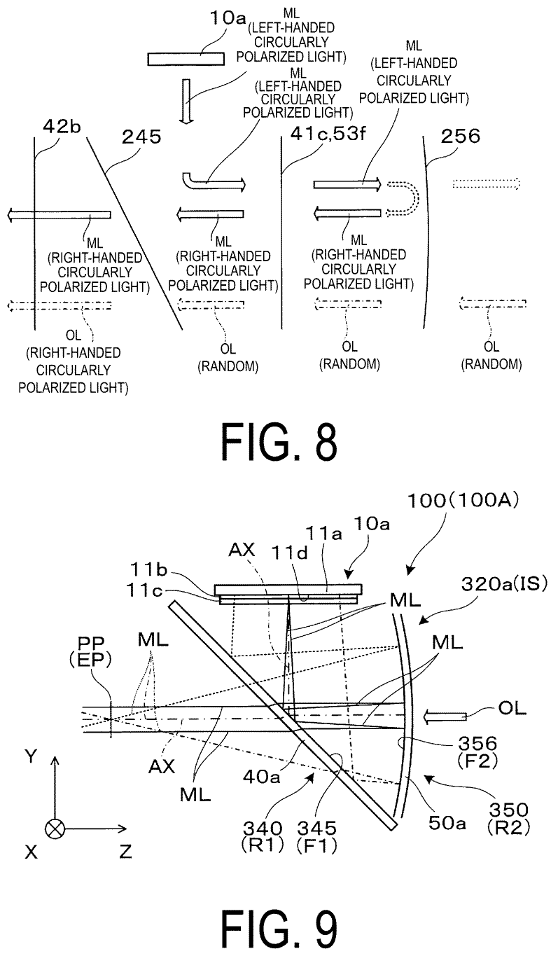

With reference to FIG. 8, the image light ML from the first display section 10a is left-handed circularly polarized light. The light is reflected at the inner-side surface 41b and the outer-side surface 41c of the first prism 41. In addition, the light enters the first optical function layer F1, that is, the cholesteric liquid crystal layer 245 in a state of the left-handed circularly polarized light, and most of the light is reflected. The image light ML reflected at the cholesteric liquid crystal layer 245 is maintained in a state of the left-handed circularly polarized light. The light passes through the outer-side surface 41c and the like, and enters the transmissive reflection layer 256 that is the second optical function layer F2. The image light ML reflected at the transmissive reflection layer 256 is converted from the left-handed circularly polarized light into the right-handed circularly polarized light, and passes through the outer-side surface 41c, the cholesteric liquid crystal layer 245, and the inner-side surface 42b in a state of the right-handed circularly polarized light as it is. With the configuration described above, the cholesteric liquid crystal layer 245 reflects most of the image light ML that is the left-handed circularly polarized light, and allows most of the image light ML that is the right-handed circularly polarized light to pass through. Thus, the image light ML is not attenuated through reflection or passing through at the cholesteric liquid crystal layer 245.

The external light OL partially passes through the transmissive reflection layer 256. The external light OL that has passed through the transmissive reflection layer 256 enters the cholesteric liquid crystal layer 245 through the outer-side surface 41c and the like. Of the external light OL, only a component of the right-handed circularly polarized light selectively passes through the cholesteric liquid crystal layer 245, and passes through the inner-side surface 42b in a state of the right-handed circularly polarized light as it is.

In the description above, it is assumed that the reflectance of the transmissive reflection layer 256 is set to 50%, for example. In this case, the image light ML outputted from the display element 11a is attenuated by the polarizing plate 11b to 50%, for example. However, even if reflected by the cholesteric liquid crystal layer 245, the light is still maintained at 50% with the original display element 11a being a reference. The image light ML reflected at the cholesteric liquid crystal layer 245 is attenuated to 25% through reflection at the transmissive reflection layer 256. Thus, the intensity of the image light ML that has passed through the cholesteric liquid crystal layer 245 and entered the pupil position PP turns to 25% with the original display element 11a being a reference. The external light OL is maintained at the 50% that is the original state.

In the first display section 10a, the polarizing plate 11b and the quarter wavelength plate 11c can be replaced with the cholesteric liquid-crystal element 111r illustrated in FIG. 5.

The cholesteric liquid crystal layer 245 may be a component configured to reflect the right-handed circularly polarized light and allow the left-handed circularly polarized light to pass through. In this case, right-handed circularly polarized light is outputted from the first display section 10a as the image light ML.

In the virtual-image display device 100A and 100B according to the second embodiment, the first reflection member R1 includes the cholesteric liquid crystal layer 245 as the first optical function layer F1, and the second reflection member R2 includes the transmissive reflection layer 256 as the second optical function layer F2. In this case, at the time of reflection or passing through at the cholesteric liquid crystal layer 245, the image light ML is hardly attenuated. In other words, with the cholesteric liquid crystal layer 56, it is possible to efficiently cause the image light ML to be reflected and pass through, and it is possible to enhance light utilization efficiency.

### Third Embodiment

Below, a virtual-image display device and the like according to a third embodiment will be described. Note that the virtual-image display device according to the third embodiment is provided by partially modifying the virtual-image display device according to the first embodiment. Thus, explanation of portions common to the virtual-image display device according to the first embodiment will not be repeated.

With reference to FIG. 9, the virtual-image display device 100A or the optical unit 100 includes the first display section 10a and a first display optical system 320a.

The first display optical system 320a is the image-forming optical system IS configured to directly form a virtual image without forming any intermediate image. The image-forming optical system IS includes a tilted mirror 340 that is the first reflection member R1, and a concave surface mirror 350 that is the second reflection member R2.

The tilted mirror 340, that is, the first reflection member R1 has a shape of parallel flat plate, includes a first support base 40a configured to support the first optical function layer F1, and is disposed in a inclined state so as to be opposed to the first display section 10a. The concave surface mirror 350, that is, the second reflection member R2 has a uniform thickness and is curved, and includes a second support base 50a configured to support the second optical function layer F2. The first support base 40a of the tilted mirror 340 includes a surface that is opposed to the second reflection member R2, and this surface is configured to support the transmissive reflection layer 345 that is the first optical function layer F1. The second support base 50a of the concave surface mirror 350 includes a surface that is opposed to the first reflection member R1, and this surface is configured to support the cholesteric liquid crystal layer 356 that is the second optical function layer F2.

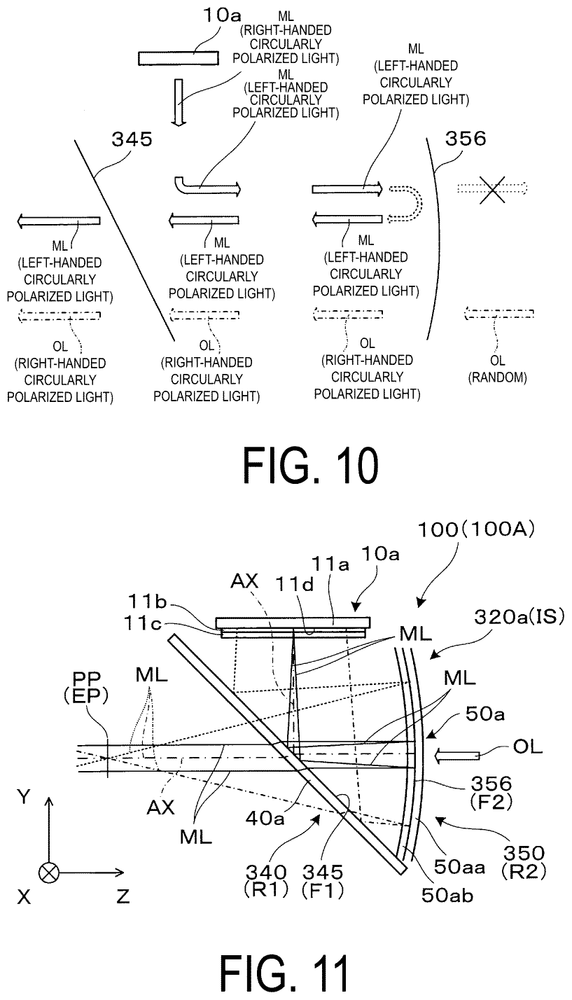

With reference to FIG. 10, the image light ML from the first display section 10a is right-handed circularly polarized light, and enters the transmissive reflection layer 345 in a state of the right-handed circularly polarized light. The image light ML reflected at the transmissive reflection layer 345 is converted from the right-handed circularly polarized light into the left-handed circularly polarized light, and enters the cholesteric liquid crystal layer 356. The image light ML reflected at the cholesteric liquid crystal layer 356 is maintained in a state of the left-handed circularly polarized light, and passes through the transmissive reflection layer 345 in a state of the left-handed circularly polarized light as it is. With the configuration described above, since the cholesteric liquid crystal layer 356 reflects most of the image light ML that is the left-handed circularly polarized light, most of the image light ML is blocked by the concave surface mirror 350, that is, by the second reflection member R2, and the light does not leak to the outside. In other words, it is possible to prevent the image light ML from being observed from the outside, which makes it possible to ensure privacy.

As for the external light OL, a component of the right-handed circularly polarized light selectively passes through the cholesteric liquid crystal layer 356, and passes through the transmissive reflection layer 345 in a state of the right-handed circularly polarized light as it is.

FIG. 11 is a diagram used to explain a modification example of the virtual-image display device 100A or the optical unit 100 illustrated in FIG. 9. In this case, the second support base 50a includes a pair of base elements 50aa and 50ab bonded together, and the cholesteric liquid crystal layer 356 that is the second optical function layer F2 is supported between the pair of base elements 50aa and 50ab.

### Fourth Embodiment

Below, a virtual-image display device and the like according to a fourth embodiment will be described. Note that the virtual-image display device according to the fourth embodiment is provided by partially modifying the virtual-image display device according to the third embodiment. Thus, explanation of portions common to the virtual-image display device according to the third embodiment will not be repeated.

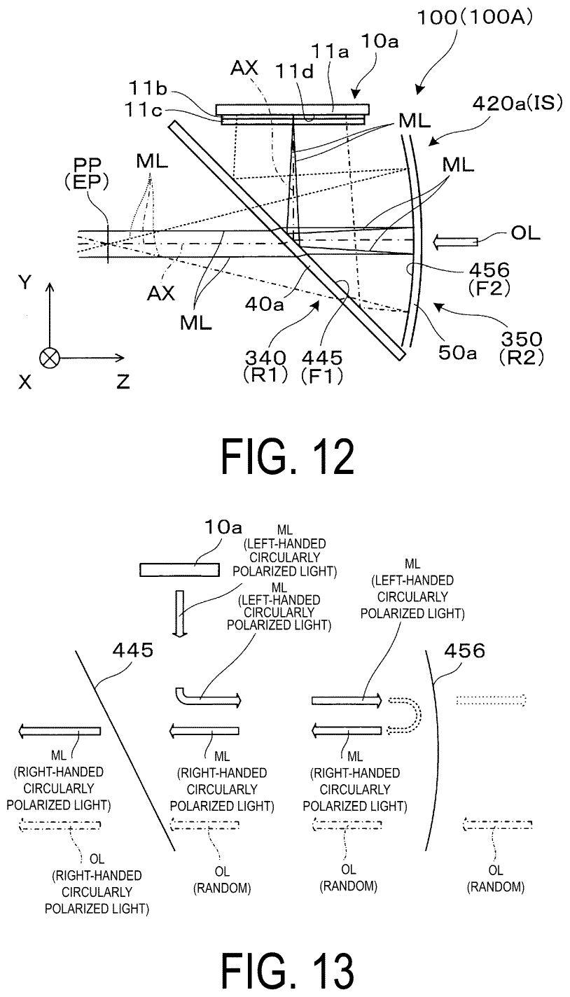

With reference to FIG. 12, the virtual-image display device 100A or the optical unit 100 includes the first display section 10a and a first display optical system 420a.

The first display optical system 420a is the image-forming optical system IS configured to directly form a virtual image without forming any intermediate image. The image-forming optical system IS includes the tilted mirror 340 that is the first reflection member R1, and the concave surface mirror 350 that is the second reflection member R2.

The first support base 40a of the tilted mirror 340 includes a surface that is opposed to the second reflection member R2, and this surface is configured to support a cholesteric liquid crystal layer 445 that is the first optical function layer F1. The second support base 50a of the concave surface mirror 350 includes an inner surface that is opposed to the first reflection member R1, and this inner surface is configured to support a transmissive reflection layer 456 that is the second optical function layer F2. In other words, the positions of the cholesteric liquid crystal layer 445 and the transmissive reflection layer 456 are swapped, as compared with the third embodiment.

With reference to FIG. 13, the image light ML from the first display section 10a is left-handed circularly polarized light, and enters the first optical function layer F1, that is, the cholesteric liquid crystal layer 445 in a state of the left-handed circularly polarized light, and most of the light is reflected. The image light ML reflected at the cholesteric liquid crystal layer 445 is maintained in a state of the left-handed circularly polarized light, and enters the transmissive reflection layer 456 that is the second optical function layer F2. The image light ML reflected at the transmissive reflection layer 456 is converted from the left-handed circularly polarized light into the right-handed circularly polarized light, and passes through the cholesteric liquid crystal layer 445 in a state of the right-handed circularly polarized light as it is. With the configuration described above, the cholesteric liquid crystal layer 445 reflects most of the image light ML that is the left-handed circularly polarized light, and allows most of the image light ML that is the right-handed circularly polarized light to pass through. Thus, the image light ML is not attenuated through reflection or passing through at the cholesteric liquid crystal layer 445.

The external light OL partially passes through the transmissive reflection layer 456. The external light OL that has partially passed through the transmissive reflection layer 456 enters the cholesteric liquid crystal layer 445, and only a component of the right-handed circularly polarized light of the external light OL selectively passes through the cholesteric liquid crystal layer 445.

### MODIFICATION EXAMPLES AND OTHERS

These are descriptions of the present disclosure with reference to the embodiments. However, the present disclosure is not limited to the embodiments described above. It is possible to implement the present disclosure in various modes without departing from the spirit of the disclosure. For example, the following modifications are possible.

Although the HMD 200 includes the first virtual-image display device 100A and the second virtual-image display device 100B in the above description, the HMD 200 may be configured such that the single first virtual-image display device 100A or second display device 100B is supported in front of the eye by the supporting device 100C.

The image-forming optical system IS of the virtual-image display device 100A and 100B may form an intermediate image on an optical path from the first display section 10a to the second reflection member R2.

The compensation flat plate 55 may not be provided in the second flat-plate member 50. In this case, the first lens 53 is covered with the second lens 54.

The first image-formation lens 30 is not limited to the lens integral with the first display section 10a. The first image-formation lens 30 may be disposed separately from the first display section 10a.

It is possible to dispose the polarizing plate 11b or the quarter wavelength plate 11c apart from the display element 11a, and, for example, at a stage subsequent to the first image-formation lens 30.

The first display section 10a may be a scanning-type display section including a laser light source or a scanner mirror.

The virtual-image display device according to the specific aspect includes: the display section configured to output image light of circularly polarized light; the first reflection member having a flat surface and configured to reflect the image light to a diagonal direction; and the second reflection member having a positive power and configured to reflect, toward the first reflection member, the image light reflected at the first reflection member, in which the first reflection member includes the first optical function layer that is one of the cholesteric liquid crystal layer and the transmissive reflection layer, and the second reflection member includes the second optical function layer that is the other one of the cholesteric liquid crystal layer and the transmissive reflection layer.

In the virtual-image display device described above, since the first reflection member reflects the image light in a diagonal direction, it is possible to avoid optical arrangement in which the display section is disposed in front of an eye. In addition, in the present virtual-image display device, since one of the first reflection member and the second reflection member includes the cholesteric liquid crystal layer, and the other one of the first reflection member and the second reflection member includes the transmissive reflection layer, it is possible to efficiently reflect the image light by the cholesteric liquid crystal layer while changing the direction of the circularly polarized light by the transmissive reflection layer, or it is possible to efficiently reflect the image light and cause the image light to pass through using the cholesteric liquid crystal layer, which makes it possible to easily enhance light utilization efficiency.

In a specific aspect, the first reflection member includes the transmissive reflection layer as the first optical function layer, and the second reflection member includes the cholesteric liquid crystal layer as the second optical function layer. In this case, most of the circularly polarized light reflected at the transmissive reflection layer of the first reflection member is reflected at the cholesteric liquid crystal layer of the second reflection member. This makes it possible to prevent the image light from leaking to the outside.

A specific aspect includes: a first prism on which the image light from the display section is incident; and a second prism bonded to the first prism to constitute a prism light-guiding member having a shape of parallel flat plate, in which the first reflection member is provided at a portion where the first prism and the second prism are bonded. In this case, the image light that has entered the first prism from the display section and been guided within the first prism is reflected at the first reflection member in a diagonal direction. The image light from the first reflection member is reflected at the second reflection member, and passes through the prism light-guiding member to enter the pupil position.

In a specific aspect, the second reflection member includes: a plano-convex first lens including: a flat surface disposed so as to be opposed to an outer-side surface of the first prism; and a convex surface disposed at an opposite side from the first prism with the flat surface being interposed between the first prism and the convex surface; and a second lens including: a concave surface having a shape obtained by inverting the convex surface of the first lens, and bonded to the convex surface with the second optical function layer being interposed between the convex surface and the concave surface; and a flat surface disposed at an opposite side from the first lens with the concave surface being interposed between the first lens and the flat surface so as to be parallel to the outer-side surface of the first prism. In this case, it is possible to naturally observe the external light through the parallel flat plate comprised of the first lens and the second lens.

A specific aspect includes a combining lens through which the image light passes when entering the first prism from the display section, the combining lens having a positive refracting power. When a virtual image is directly formed without any intermediate image being formed, it is possible to secure the refracting power by the combining lens, the first lens, and the second reflection member. This makes it possible to secure a magnifying power while suppressing an increase in the length of optical path, which makes it possible to prevent an increase in the size of the optical system.

In a specific aspect, the first reflection member includes a first support base having a shape of parallel flat plate and configured to support the first optical function layer, the first reflection member being disposed in a inclined state so as to be opposed to the display section, and the second reflection member has a uniform thickness and is curved, and includes a second support base configured to support the second optical function layer. In this case, the first reflection member is disposed in a inclined state between the second reflection member and the pupil position; the image light from the display section is reflected at the first reflection member in a diagonal direction; the image light from the first reflection member is reflected at the second reflection member; and the image light passes through the first reflection member to enter the pupil position.

In a specific aspect, the second support base includes an inner surface that is opposed to the first reflection member, the inner surface being configured to support the second optical function layer, or includes a pair of base elements bonded together, the second optical function layer being supported between the pair of base elements.

In a specific aspect, the display section includes: a display element configured to output the image light; a polarizing plate disposed so as to be opposed to the display element; and a quarter wavelength plate disposed so as to be opposed on an opposite side of the polarizing plate from the display element. Here, the display element is configured to output the image light containing polarized light in one direction or two directions.

In a specific aspect, the display section includes a display element configured to output the image light, and a cholesteric liquid-crystal element disposed so as to be opposed to the display element. Here, the display element is a display of organic EL element, for example, and is configured to output the image light containing polarized light in at least one direction.

In a specific aspect, the display section includes: a display element configured to output the image light that is polarized light in a predetermined direction; and a quarter wavelength plate disposed so as to be opposed to the display element. Here, the display element is a display of liquid crystal element, for example, and is configured to output the image light that is polarized light in a predetermined direction.

The optical unit according to one aspect of the present disclosure includes: the display section configured to output image light of circularly polarized light; the first reflection member having a flat surface and configured to reflect the image light to a diagonal direction; and the second reflection member having a positive power and configured to reflect, toward the first reflection member, the image light reflected at the first reflection member, in which the first reflection member includes the first optical function layer that is one of the cholesteric liquid crystal layer and the transmissive reflection layer, and the second reflection member includes the second optical function layer that is the other one of the cholesteric liquid crystal layer and the transmissive reflection layer.

What is claimed is:

1. A virtual-image display device, comprising:
a display section configured to output image light of circularly polarized light;
a first reflection member having a flat surface and configured to reflect the image light to a diagonal direction; and
a second reflection member having a positive power and configured to reflect, toward the first reflection member, the image light reflected at the first reflection member, wherein
the first reflection member includes a first optical function layer that is one of a cholesteric liquid crystal layer and a transmissive reflection layer, and
the second reflection member includes a second optical function layer that is the other one of the cholesteric liquid crystal layer and the transmissive reflection layer.

2. The virtual-image display device according to claim 1, wherein
the first reflection member includes the transmissive reflection layer as the first optical function layer, and
the second reflection member includes the cholesteric liquid crystal layer as the second optical function layer.

3. The virtual-image display device according to claim 1, further comprising:
a first prism on which the image light from the display section is incident; and
a second prism bonded to the first prism to constitute a prism light-guiding member having a shape of parallel flat plate, wherein
the first reflection member is provided at a portion where the first prism and the second prism are bonded.

4. The virtual-image display device according to claim 3, wherein
the second reflection member includes:
a plano-convex first lens including:
a flat surface disposed to be opposed to an outer-side surface of the first prism; and
a convex surface disposed at an opposite side from the first prism with the flat surface being interposed between the first prism and the convex surface; and
a second lens including:
a concave surface having a shape obtained by inverting the convex surface of the first lens, the concave surface being bonded to the convex surface with the second optical function layer being interposed between the convex surface and the concave surface; and
a flat surface disposed at an opposite side from the first lens with the concave surface being interposed between the first lens and the flat surface so as to be parallel to the outer-side surface of the first prism.

5. The virtual-image display device according to claim 4, further comprising:
a combining lens through which the image light passes when entering the first prism from the display section, the combining lens having a positive refracting power.

6. The virtual-image display device according to claim 1, wherein
the first reflection member includes a first support base having a shape of parallel flat plate and configured to support the first optical function layer, the first reflection member being disposed in an inclined state so as to be opposed to the display section, and
the second reflection member has a uniform thickness and is curved, and includes a second support base configured to support the second optical function layer.

7. The virtual-image display device according to claim 6, wherein
the second support base includes an inner surface that is opposed to the first reflection member, the inner surface being configured to support the second optical function layer, or includes a pair of base elements bonded together, the second optical function layer being supported between the pair of base elements.

8. The virtual-image display device according to claim 1, wherein
the display section includes:
a display element configured to output the image light;
a polarizing plate disposed so as to be opposed to the display element; and
a quarter wavelength plate disposed on an opposite side of the polarizing plate from the display element.

9. The virtual-image display device according to claim 1, wherein
the display section includes:
a display element configured to output the image light; and
a cholesteric liquid-crystal element disposed so as to be opposite to the display element.

10. The virtual-image display device according to claim 1, wherein
the display section includes:
a display element configured to output the image light that is polarized light in a predetermined direction; and
a quarter wavelength plate disposed so as to be opposed to the display element.

11. An optical unit comprising:
a display section configured to output image light of circularly polarized light;
a first reflection member having a flat surface and configured to reflect the image light to a diagonal direction; and
a second reflection member having a positive power and configured to reflect, toward the first reflection member, the image light reflected at the first reflection member, wherein
the first reflection member includes a first optical function layer that is one of a cholesteric liquid crystal layer and a transmissive reflection layer, and
the second reflection member includes a second optical function layer that is the other one of the cholesteric liquid crystal layer and the transmissive reflection layer.
